(19) United States
(12) Patent Application Publication
(10) Pub. No.: US 2008/0053884 A1
(43) Pub. Date: Mar. 6, 2008

(54) Liquid filter element having keys

(75) Inventors: James N. Marshall, Elm Creek, NE (US); Thomas C. Richmond, Kearney, NE (US); Joshua L. Quackenbush, Kearney, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/516,190

(22) Filed: Sep. 6, 2006

(51) Int. Cl. B01D 35/00

(52) U.S. Cl. 210/232

(57) ABSTRACT

A filter element having a plurality of keys for actuating a locking mechanism of a valve of a filter is provided. The keys are formed on an interior side of a first end cap and extend axially inward toward a second opposite end cap. In one embodiment, the keys are integrally formed in an inner annular wall. In another embodiment, the filter media is embedded into generally flat surfaces of the end caps. The keys function to unlock the locking mechanism of the valve indicating that a filter element is being used.

### FIELD OF THE INVENTION

This invention generally relates to liquid filters and more particularly to liquid filter elements having keys for actuating valves.

### BACKGROUND OF THE INVENTION

Fluid filtration systems for vehicle engines will typically include a filter housing and a filter element. It is common in such fluid filter systems that the filter housing will incorporate a standpipe with a valve on it which when opened permits the flow of fluid through the filtration system. It is also known that when the filter element is removed that the valve will close to thereby prevent impurities from passing downstream and getting into the standpipe during the filter replacement process. While valves on standpipes do provide the aforementioned benefits, some manufacturers have elected to employ tricks for actuating the valve such as shown in U.S. Pat. No. 6,495,042 to Steven R. Knight in which the valve is protected by an additional latch member. This type of arrangement has been commercially employed but unfortunately is disadvantageous to everyone in that it increases the difficulty for maintenance, increases the overall costs of providing the filtration system and has no real benefit to consumers. Nevertheless, due to the existing use of such systems, there are needs for replacement filters for these types of applications. Additionally, there is a need for reliable, cost effective and practical filters for these applications, including components which are easy to manufacture and assemble, to which the present invention is directed.

### BRIEF SUMMARY OF THE INVENTION

The invention provides an improved filter element having keys for unlocking a valve structure. As such, the present invention provides a filter element that is configured to prevent improper filter elements from being installed on a standpipe. Furthermore, the present invention simplifies or eliminates much of the structure previously, which reduces complexity and manufacturing costs.

According to one embodiment, the invention provides a filter element having an axially extending cylindrical ring of filter media defining an interior cavity. A closed end cap and an open end cap are attached to opposite ends of the filter media. Each end cap has an interior side facing the ring of filter media and an exterior side facing away from the ring of filter media. The closed end cap has an inner annular wall, an outer annular wall and a disc portion that in combination define an annular well for receipt of bonding material. Cured bonding material in the annular well secures the closed end cap the filter media. The closed end cap includes at least one filter housing mounting structure. A plurality of keys on the inner annular wall extend axially inward toward the open end cap. The keys form a terminating axially inner end of the inner annular wall. The inner annular wall serves dual functions in locating keys and damming the bonding material.

In yet another embodiment, the invention provides a filter element comprising a cylindrical ring of filter media defining an interior cavity. The filter media extends axially between opposite ends. A closed and an open end cap are affixed to the opposite ends of the filter media. Each end cap has an interior side generally facing the ring of filter media and an exterior side generally facing away from the ring of filter media. The closed end cap is formed of plastic material and includes a disc portion with an interior surface facing the open end cap. One end of the filter media is embedded in the plastic material of the disc portion. A filter housing mounting structure is included on the closed end cap. A plurality of keys are on the interior surface of the disc portion and project axially inward from the interior surface of the disc portion.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional illustration of an exemplary embodiment of a filter element in accordance with the teachings of the present invention;

FIG. 2 is a cross-sectional illustration of the filter element of FIG. 1 attached to filter housing cap having the filter element uninstalled such that the keyed valve is in a closed position;

FIG. 3 is a cross-sectional illustration of the filter element and filter housing of FIG. 2 having the filter element installed such that the keyed valve is in an open position; and

FIG. 4 is a cross-sectional illustration of an alternative embodiment of a filter element according to the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

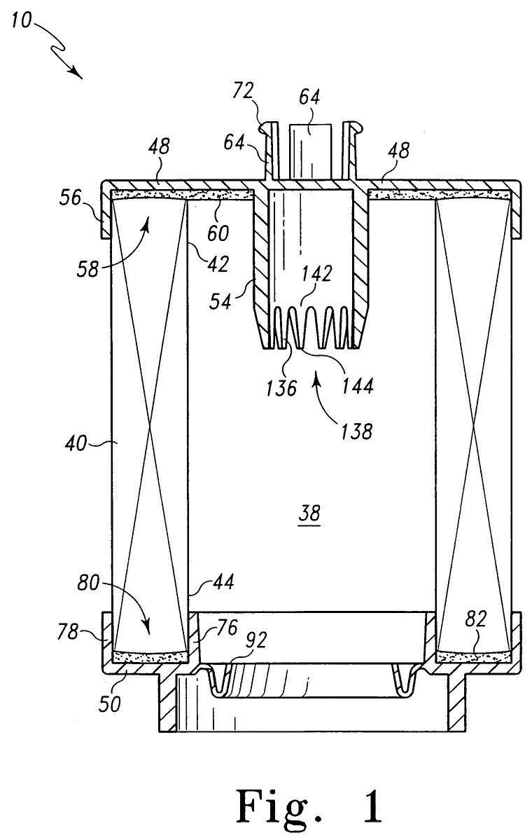

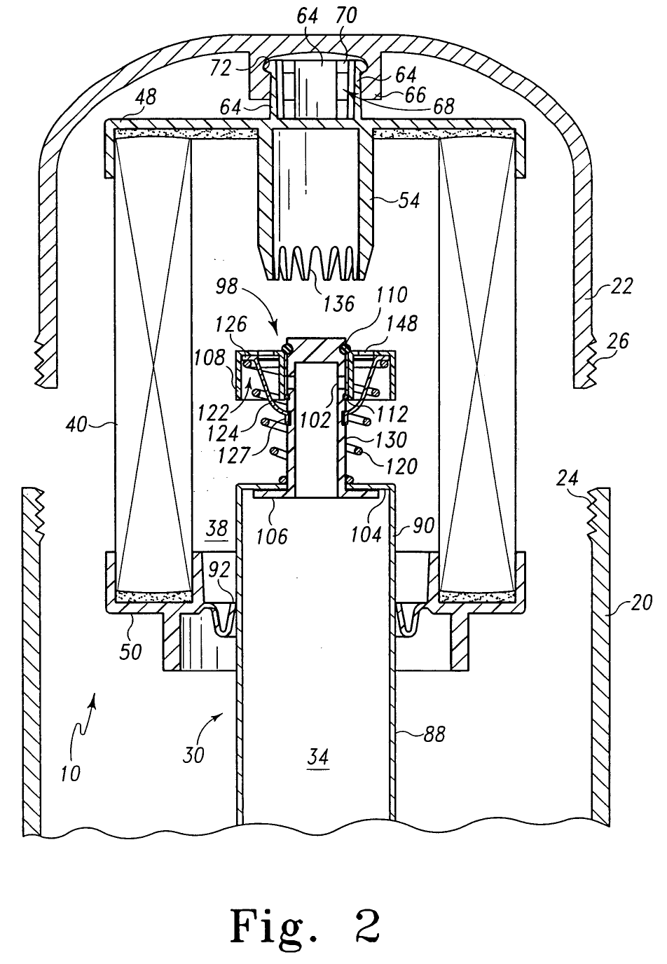

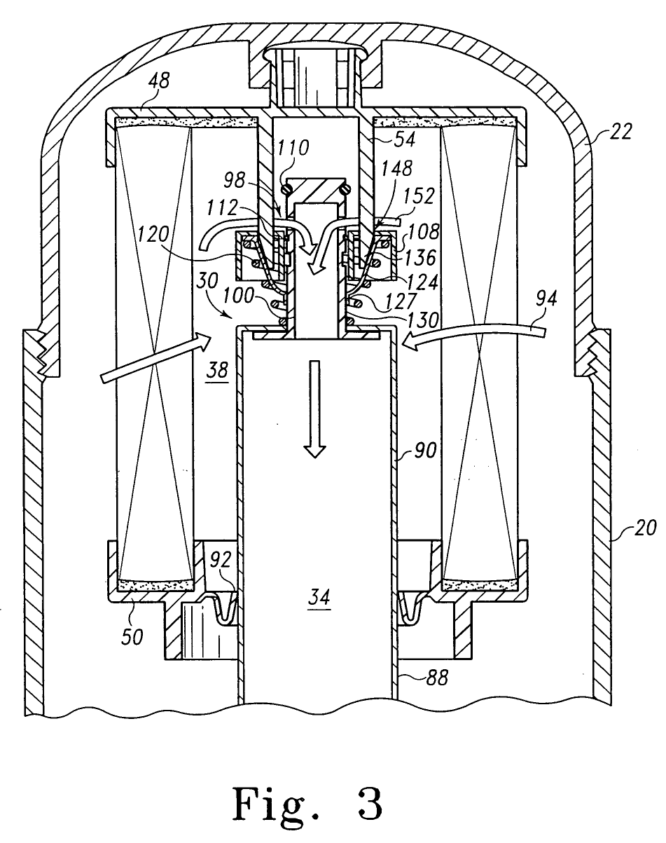

FIG. 1 illustrates a first embodiment of a liquid filter element 10 in accordance with the teachings of the present invention. The filter element 10 may be applied to filter impurities from fluids such as fuels, lubricants, hydraulic fluids and other the like fluids used in or by engines of vehicles or engines. As illustrated in FIGS. 2 and 3, a filter housing, illustrated in simplified form, houses and protects the filter element 10. The filter housing includes a housing receptacle 20 and a housing cap 22. The housing cap 22 mounts to the housing receptacle 20 by cooperating threads 24, 26. The housing receptacle 20 is typically connected to a filter head (not shown) of the engine, or a fuel pump which includes a dirty fluid port that supplies dirty fluid from the engine upstream of the filter element 10 and a clean fluid port downstream of the filter element 10 that returns the clean fluid to the engine after it passes through the filter element 10. Typically, the housing receptacle 20 and housing cap 22 are formed from aluminum, cast iron, steel, plastic or other substantially rigid materials that are non-reactive with the fluid being filtered.

The filter element 10 mounts to and partially surrounds a standpipe 30 that extends axially within the housing receptacle 20. The standpipe 30 includes a central cavity 34 that extends the axial length of the standpipe 30 and serves as a clean fluid return passage. As such, the central cavity 34 fluidly communicates with the interior cavity 38 of a filter element 10 when installed on the standpipe 30.

The filter element 10 includes a generally cylindrical ring of filter media 40 that extends between a first end 42 and an opposite second end 44. The filter media 40 forms the interior cavity 38. The filter media 40 may be any standard filter media including preferably pleated filter paper formed from cellulose material. The standpipe 30 extends into the internal cavity 38 of the filter element 10, when the filter element 10 is mounted to the standpipe 30.

The filter element 10 includes closed and open end caps 48, 50 fixed to the first opposite ends 42, 44 of the filter media 40, respectively. In an embodiment, the end caps 48, 50 are formed from molded plastic. However, one or perhaps both of the end caps 48, 50 may be formed from other materials including metal. Additionally, while unitary one piece end caps are illustrated, the end caps may comprise multiple pieces

In the illustrated embodiment, an interior side of the closed end cap 48 includes an inner annular wall 54 and an outer annular wall 56 that extend axially inward toward the filter media 40 and the open end cap 50. The annular walls 54, 56 are coaxial with the longitudinal central axis of the filter media 40 and are radially spaced apart forming a first annular channel 58 therebetween. One end 42 of the filter media 40 is fixed to the closed end cap 48 within the first annular channel 58, which forms a well for holding bonding material 60, which may include plastisol, or other similar potting material or adhesive, that fixes the closed end cap 48 to the filter media 40. The boding material 60 seals the end of the filter media to the end cap 48 to prevent fluid from short circuiting the filter media 40. In an embodiment, the filter media 40 is radially positioned proximate the outer annular wall 56 and is radially spaced apart from the inner annular wall 54, forming a gap between the inner annular wall 54 and the radial inner periphery of the filter media 40. In an embodiment, the gap between the inner periphery of the filter media 40 and the inner annular wall 54 may be greater than 25% of the thickness of the wall of the cylindrical ring of filter media 40.

Furthermore, the closed end cap 48 includes a plurality of mounting prongs 64 on an exterior side of the closed end cap 48 that extend axially away from the open end cap 50 and the filter media 40. The mounting prongs 64 connect to and engage a cooperating filter mount 66 of the housing cap 22 of the filter housing. The filter mount 66 forms a cavity 68 that receives the mounting prongs 64. When received in the cavity 68, the mounting prongs 64 resiliently flex to secure the filter element 10 to the cap 22. The cavity 68 may include an annular groove 70 that receives a rounded head 72 of each mounting prong 64 to further secure the filter element 10 to the cap 22. The mounting prongs 64 are preferably unitarily formed with the rest of the closed end cap 48. The illustrated embodiment includes multiple mounting prongs 64, however, one of ordinary skill will recognize that any number of mounting prongs may be used, including only a single mounting prong.

The open end cap 50 includes an inner annular wall 76 and an outer annular wall 78 that extend axially toward the filter media 40 and the closed end cap 48. The annular walls 76, 78 are coaxial with the longitudinal central axis of the filter media 40 and are radially spaced apart forming a second annular channel 80, which similarly forms a well for holding plastisol 82 for potting the second end 44 of the filter media 40 therein.

The open end cap 50 includes a radially inward extending sealing lip 92 that defines a central aperture. The central aperture receives the standpipe 30 therethrough and is sized to sealingly engage the outer surface 88 of a main pipe 90 of the standpipe 30 to form a radial seal therebetween. The seal between the second end cap 44 and the standpipe 30 prevents dirty fluid, indicated generally as arrows 94, from short circuiting the filter media 40.

The distal end of the standpipe 30 includes a keyed flow valve, indicated generally by reference number 98, that prevents fluid from flowing through the filter housing if the filter element 10 is removed and not replaced. The standpipe 30 includes a pipe stub 100 that extends axially from the end wall 104 of the main pipe 90 and includes at least one inlet hole 102 that passes through the cylindrical sidewall of the pipe stub 100. The pipe stub 100 extends through an aperture in the end wall 104 of the main pipe 90 and includes a radially extending annular flange 106 positioned within the central cavity 34 of the main pipe 90 that abuts with the interior side of the end wall 104 forming a seal therebetween. The seal prevents fluid from short circuiting a valve 98.

The valve includes a valve member 108 that circumscribes the pipe stub 100 and functions to open and close the inlet hole 102. The valve member 108 is configured to move axially relative to the pipe stub 100 between a first position (FIG. 2) wherein the valve member 108 closes the inlet hole 102 and a second position (FIG. 3) wherein the valve member 108 opens the inlet hole 102.

To prevent fluid from short circuiting the valve member 108 in the closed position, a pair of seals 110, 112 are axially spaced apart and having the inlet hole 102 interposed axially therebetween. The seals 110, 12 seal the valve member 108 relative to the pipe stub 100. It is preferable to have the seals 110, 112 seated in annular grooves in the outer surface of the pipe stub 100. As illustrated, the seals 110, 112 may be formed from rubber or rubber like o-rings. When the valve 98 is in a closed position (see FIG. 2), the first seal 110 sealingly engages a sealing shoulder 114 of the valve member 108 and the pipe stub 100 proximate an axial side of the inlet hole 102 proximate the distal end of the pipe stub 100. The second seal 112 sealingly engages the valve member 108 and the pipe stub 100 proximate the main pipe side of the inlet hole 102. When actuated axially towards the main pipe 90 to the second position, the valve member 108 disengages from the first seal 110 and slides axially past the inlet hole 102, thereby opening the valve 98 and fluidly communicating the internal cavity 34 of the standpipe 30 with the exterior of the standpipe 30 and the interior cavity 38 of the filter element 10 when mounted to the standpipe 30.

A coil spring 120 positioned between the end wall 104 of the main pipe 90 and the valve member 108 biases the valve member 108 toward the closed position. To lock the valve 98 in the closed position, the valve 98 includes a locking member 122 that includes a plurality of resilient locking prongs 124. The locking prongs 124 are interconnected to one another at an annular common ring portion 126. Each locking prong 124 extends radially inward against the pipe stub 100. The locking prongs 124 also extend axially toward the end wall 104 main pipe 90. In the closed position, the distal ends 127, or heads, of the locking prongs 124 engage an annular locking channel 128 formed in the outer surface 130 of the pipe stub 100 preventing axial movement of the valve member 108. Particularly, the locking prongs 124 prevent axially movement in an axial direction toward the main pipe 90. The interaction of the sealing shoulder 114 and the first seal 110 prevent axial movement away from the main pipe 90 when the valve member 108 is in the closed position.

To open the valve 98, the locking prongs 124 are biased such that the distal ends 127 disengage the locking channel 128 allowing the valve member 108 to move axially toward the main pipe 90. The filter element 10 biases the locking prongs 124 and actuates the valve member 108 between the first and second positions as will be more fully explained below.

In the embodiment illustrated in FIGS. 1-3, the closed end cap 48 includes a plurality of keys 136 formed unitarily therewith. The keys 136 can be unitarily molded into the inner annular wall 54 of the closed end cap 48. The keys 136 define a plurality of peaks 138 separated by a plurality of valleys that are angularly spaced apart around the annular inner annular wall 54. In an embodiment, the keys 136 taper radially inward from a connection interface 142 to the tip 144. The keys 136 extend in an axial inward direction, generally parallel to the longitudinal axis of the filter element 10 and are positioned within the cavity 38 formed by the filter media 40 As illustrated, the connection interface 142 of each key 136 has a radial thickness that is generally equal to the radial thickness of the rest of the inner annular wall 54. As such, radial thickness of the transition from the generally continuous portion of the inner annular wall 54 to the key 136 of the inner annular wall 54 is generally equal. Additionally, the keys 136 taper angularly such that the keys 136 are generally pyramidal in shape. However, keys having other profiles may be used such as keys having a constant radial thickness as well as a constant angular thickness. The narrowest portion, or terminating portion, of the illustrated valleys provides a scalloped or rounded profile. However, these portions could be flat or tapered. Furthermore, the first end cap may include any number of keys depending on the pattern required for the value 98. Furthermore, the key 136 are angularly spaced apart relative to one another depending on the pattern of the key receiving slots 148 in the valve member 108.

The keys 136 function to disengage the locking prongs 124 from the locking channel 128 thereby allowing the valve member 108 to actuate axially to change the valve 98 from the closed first position to the open second position. More specifically, when axially sliding the filter element 10 onto the standpipe 30 each key 136 passes axially through a corresponding key receiving slot 148 in the valve member 108. The keys 136 engage corresponding locking prongs 124 and bias the locking prongs 124 out of engagement with the locking channel 128 in the pipe stub 100. Generally, the keys 136 bias the locking prongs 124 radially outward or away from the pipe stub 100. More particularly, as the keys 136 move axially towards the main pipe 90, the keys 136 contact the locking prongs 124, which are canted relative to the axial movement and apply a radial loading on the locking prongs 124. Once the locking prongs 124 disengage the locking channel 128 the valve member 108 is axially actuated towards the main pipe 90. The axial actuation of the valve member opens the valve 98 and fluidly communicating the interior cavity 38 of the filter element 10 with the interior cavity 34 of the standpipe 30 through inlet hole 102, as illustrated by arrows 152 representing clean fluid flow through the valve 98.

During the actuation of the valve member 108, the coil spring 120 is compressed such that when the filter element 10 is removed from the standpipe 30, the coil spring 120 expands and actuates the valve member 108 back to the first position, thereby reclosing the valve 98. Further, with the housing cap 22 threadedly secured to the receptacle 20, the combination axially secures the filter element 10 in a fixed axial position such that the filter element 10 cannot be axially biased away from the main pipe 90 by the coil spring 122, maintaining the valve in an open position.

After the filter element 10 has been installed and positioned over the standpipe 30 and the valve member 108 has been actuated to the second position, and fluid may flow through the filter system. As illustrated in FIG. 3, dirty fluid, indicated generally by arrows 94, flows into the filter housing cap 22 and housing receptacle 20 from a dirty fluid source (not shown) between the filter housing and the outer periphery of filter element 10. The dirty fluid 94 is cleaned as it passes through the filter media 40, as indicated generally by arrows 154, and into the central cavity 38 of the filter media 40. With the valve member 108 actuated to the open position, the clean fluid, indicated generally by arrows 152, passes through the valve 98 and into the interior passage 34 of the standpipe 30, as discussed previously, and then returns to the component requiring the fluid.

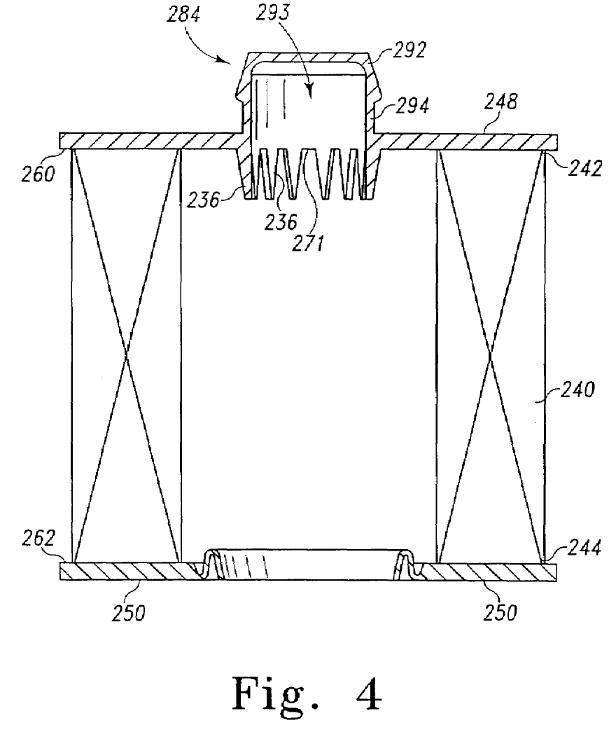

FIG. 4 illustrates an alternative embodiment of a filter element 210 in accordance with the teachings of the present invention. The filter element 210 of FIG. 4 is similar to filter element 10 of FIGS. 1-3 and as such only those features that are different will be discussed in detail. The filter element 120 includes a ring of filter media 240 extending between a first end 242 and a second end 244 and includes closed and open end caps 248, 250 secured the first and second ends 242, 244, respectively. However, the end caps 248, 250 do not need to have the axially inward extending annular walls. In this embodiment, the ends 242, 244 of the filter media 240 are directly embedded into plastic end cap material along the interior surfaces 260, 262 of the closed and open end caps 248, 250, respectively. In this embodiment, the end caps 248, 250 include disc portions that are generally planar to provide for the embedded filter ends 242, 244. As illustrated, end cap 250 includes an inner lip seal, similar to sealing lip 92 of the previous embodiment that provides a radial seal. However, other sealing methods could be used such as a seal on the outer surface of end cap 250. Furthermore, seals and sealing lips could be provided by o-rings, felt gaskets, or other similar sealing devices.

The first end cap 248 includes a plurality of keys 236 that extend axially inward directly from the disc portion. The keys 236 are generally similar to and function similarly as the keys 136 of the previous embodiment. However, in an embodiment, intermittent segments 271 of the disc portion are interposed between the keys 236. The surface of these disc portion segments 271 are substantially flat and are formed by and generally planar with the inner surface 260 of the first end cap 248 in which the filter media 240 is embedded. Furthermore, the keys 236 extend directly from the interior surface of 260 of the first end cap 248.

Furthermore, in this embodiment, the first end cap 248 includes a cylindrical stub 284, or shaft, that extends axially away from the second end cap 248 for mounting the filter element 210 to a filter housing cap similar to housing cap 22 of FIGS. 2 and 3. The stub 284 includes a generally frusto-conical portion 292 that forms a head that is received into a filter mount of a filter housing. In an embodiment, the frusto-conical 292 portion has a maximum diameter that is larger than the diameter of a connecting wall 294 forming an engagement shoulder that can engage a groove formed within the filter mount of the filter housing. As illustrated, the stub 284 is generally hollow forming a cavity 293 therein. The cavity 293 can receive the distal end of the pipe stub 100 and also improves molding by maintaining a more uniform material thickness.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element comprising:
a cylindrical ring of filter media defining an interior cavity, the filter media extending axially between opposite ends;
end caps affixed to the opposite ends of the filter media including a closed end cap and an open end cap, each end cap having an interior side generally facing the ring of filter media and an exterior side generally facing away from the ring of filter media, the closed end cap having an inner annular wall and an outer annular wall and a disc portion that in combination define an annular well for receipt of bonding material;
cured bonding material in the annular well securing the closed end cap to one end of the filter media;
at least one filter housing mounting structure on the closed end cap;
a plurality of keys on the inner annular wall extending axially inward toward the open end cap; and
wherein the keys form a terminating axially inner end of the inner annular wall and whereby the inner annular wall serves dual functions in locating keys and damming the bonding material.

2. The filter element of claim 1, wherein the inner annular wall of the closed end cap excludes any base structure projecting radially therefrom.

3. The filter element of claim 2, wherein the inner annular wall of the closed end cap has a radial cross sectional thickness that at least remains constant or reduces in thickness as the annular wall extends axially inward.

4. The filter element of claim 3, wherein the keys have a radial cross sectional thickness, and wherein as the keys extend axially inward the radial cross sectional thickness remains constant and/or reduces.

5. The filter element of claim 4, wherein keys form a plurality of peaks and valleys.

6. The filter element of claim 4, wherein the peaks are radially and angularly tapered.

7. The filter element of claim 1, wherein the at least one filter housing mount includes a plurality of a angularly spaced apart resilient prongs extending from the disc portion.

8. The filter element of claim 1, wherein the at least one filter housing mount includes a cylindrical mounting stub having a outward projecting shoulder.

9. The filter element of claim 1 wherein the filter media has a media thickness defined by the radial distance between an outer surface of the filter media and an inner surface of the filter media, and wherein the distance between the inner annular wall and the outer annular wall of the closed end cap is at least 25 percent greater than the media thickness.

10. The filter element of claim 1, wherein the open end cap defines a circular sealing lip defining a central opening generally coaxial with the inner annular wall.

11. A filter element comprising:
a cylindrical ring of filter media defining an interior cavity, the filter media extending axially between opposite ends;
end caps affixed to the opposite ends of the filter media including a closed end cap and an open end cap, each end cap having an interior side generally facing the ring of filter media and an exterior side generally facing away from the ring of filter media, the closed end cap being formed of plastic material and including a disc portion with an interior surface facing the open end cap, wherein one end of the filter media is embedded in the plastic material of the disc portion;
at least one filter housing mounting structure on the closed end cap; and
a plurality of keys on the interior surface of the disc portion and projecting axially inward from the interior surface of the disc portion.

12. The filter element of claim 11, wherein the closed end cap excludes any annular walls extending axially inward along the interior cavity.

13. The filter element of claim 11, wherein the keys have a radial cross sectional thickness, and wherein as the keys extend axially inward the radial cross sectional thickness remains constant and/or reduces.

14. The filter element of claim 13, wherein keys form a plurality of peaks and valleys.

15. The filter element of claim 14, wherein the peaks are radially and angularly tapered.

16. The filter element of claim 11, wherein the at least one filter housing mount includes a plurality of angularly spaced apart resilient prongs extending from the disc portion.

17. The filter element of claim 16, wherein the at least one filter housing mount includes an axially outward projecting cylindrical mounting stub having a outward projecting shoulder.

18. The filter element of claim 17, wherein the keys are discrete projections formed by a plurality of tapered peaks and valleys angularly spaced apart in a circular configuration.

19. The filter element of claim 18, wherein the valleys are substantially flat and co-planer with the interior side of the first end cap.

20. The filter element of claim 11, wherein the open end cap defines a circular sealing lip defining a central opening generally coaxial with the inner annular wall.
